(19) United States
(12) Patent Application Publication
(10) Pub. No.: US 2023/0089561 A1
(43) Pub. Date: Mar. 23, 2023

(54) EMOTION ESTIMATION APPARATUS, EMOTION ESTIMATION METHOD, AND NON-TRANSITORY COMPUTER READABLE MEDIUM

(71) Applicant: NEC Corporation, Minato-ku, Tokyo (JP)

(72) Inventors: Shigeru SEKINE, Tokyo (JP); Tsuyoshi Shibata, Tokyo (JP)

(73) Assignee: NEC Corporation, Minato-ku, Tokyo (JP)

(21) Appl. No.: 17/800,450

(22) PCT Filed: Mar. 11, 2020
(86) PCT No.: PCT/JP2020/010454

§ 371 Date: Aug. 17, 2022

(51) Int. Cl. G06V 20/52; G06V 40/16

(52) U.S. Cl. CPC G06V 20/52; G06V 40/174

(57) ABSTRACT

An emotion estimation apparatus (10) includes an emotion acquisition unit (110) and an output unit (120). The emotion acquisition unit (110) acquires, for each of a plurality of regions within a facility, an estimated value related to magnitude of specific emotion being felt by at least one person being present in the region. The emotion acquisition unit (110) acquires the estimated value by processing an image acquired by capturing the region. When there is a region where the estimated value satisfies a criterion, the output unit (120) outputs information that determines the region. The criterion is set for each of the plurality of regions.

### TECHNICAL FIELD

The present invention relates to an emotion estimation apparatus, an emotion estimation method, and a program.

### BACKGROUND ART

In recent years, an image capturing unit is installed in various places. Then, by processing an image generated by the image capturing unit, various pieces of information are generated. For example, Patent Document 1 describes estimating a degree of congestion or a degree of dissatisfaction of a person by analyzing an image.

### RELATED DOCUMENT

### Patent Document

[Patent Document 1] International Publication No. WO2016/002400

### DISCLOSURE OF THE INVENTION

### Technical Problem

In a case where a deficiency or an anomaly has occurred in a facility, a person being present in a region of the facility is likely to have specific emotion, for example, dissatisfaction. In view of the above, an inventor of the present invention has conceived that it is possible to detect a deficiency or an anomaly that has occurred in a facility by detecting specific emotion being felt by a person. One of objects of the present invention is to detect a deficiency or an anomaly that has occurred in a facility, based on emotion being felt by a person.

### Solution to Problem

The present invention provides an emotion estimation apparatus including:

an emotion acquisition unit that acquires for each of a plurality of regions within a facility, an estimated value related to magnitude of specific emotion being felt by at least one person being present in the region; and

an output unit that outputs predetermined information, when there is the region where the estimated value satisfies a criterion, wherein

the criterion is set for each of the plurality of regions.

The present invention provides an emotion estimation method including:

by a computer,

acquiring, for each of a plurality of regions within a facility, an estimated value related to magnitude of specific emotion being felt by at least one person being present in the region; and

outputting predetermined information, when there is the region where the estimated value satisfies a criterion, wherein

the criterion is set for each of the plurality of regions.

The present invention provides a program causing a computer to include:

a function of acquiring, for each of a plurality of regions within a facility, an estimated value related to magnitude of specific emotion being felt by at least one person being present in the region; and

a function of outputting predetermined information, when there is the region where the estimated value satisfies a criterion, wherein

the criterion is set for each of the plurality of regions.

### Advantageous Effects of the Invention

The present invention enables to detect a deficiency or an anomaly that has occurred in a facility, based on emotion being felt by a person.

### BRIEF DESCRIPTION OF THE DRAWINGS

The above-described object, the other objects, features, and advantages will become more apparent from suitable example embodiments described below and the following accompanying drawings.

FIG. 1 is a diagram illustrating a usage environment of an emotion estimation apparatus according to a first example embodiment.

FIG. 2 is a diagram illustrating one example of a functional configuration of the emotion estimation apparatus.

FIG. 3 is a diagram illustrating a hardware configuration example of the emotion estimation apparatus.

FIG. 4 is a flowchart illustrating an operation example of the emotion estimation apparatus.

FIG. 5 is a flowchart illustrating a first example of processing to be performed in step S20 in FIG. 4.

FIG. 6 is a flowchart illustrating a second example of processing to be performed in the step S20 in FIG. 4.

FIG. 7 is a flowchart illustrating a third example of processing to be performed in the step S20 in FIG. 4.

FIG. 8 is a flowchart illustrating processing to be performed by an emotion estimation apparatus according to a second example embodiment.

### DESCRIPTION OF EMBODIMENTS

In the following, example embodiments according to the present invention are described with reference to the drawings. Note that, in all drawings, a similar constituent element is indicated by a similar reference sign, and description thereof is not repeated as appropriate.

[First Example Embodiment]

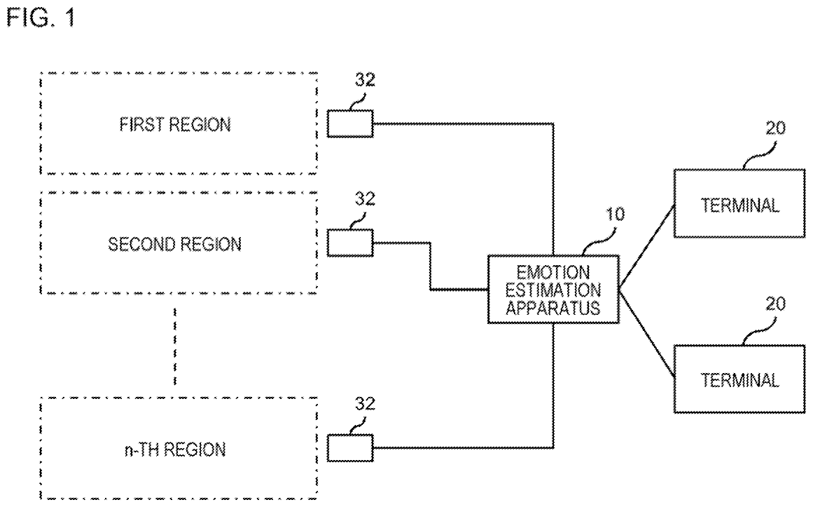

FIG. 1 is a diagram illustrating a usage environment of an emotion estimation apparatus 10 according to the present example embodiment. The emotion estimation apparatus 10 estimates emotion of a person being present in a specific region within a facility, and estimates that a deficiency or an anomaly has occurred in the region by using a result of the estimation. In the present example embodiment, the facility is an airport, a station, a store, an event venue, and the like, but is not limited to these places.

In the present example embodiment, a plurality of image capturing units 32 are provided in a facility. The image capturing unit 32 is provided, for example, for each region, and image capturing unit identification information is appended to identify the image capturing unit 32. Herein, a region may be set for each piece of equipment within a facility. For example, the region is at least one of a toilet, an aisle, and a place where a predetermined apparatus (e.g., a ticket sales apparatus, or a check-in apparatus at an airport) is installed, and a vicinity thereof, but is not limited to these places. An image to be generated by the image capturing unit 32 may be a still image or may be a moving image.

The emotion estimation apparatus 10 estimates emotion of a person being present in a region associated with the image capturing unit 32, by processing an image generated by the image capturing unit 32. Herein, when a ratio of a person who has specific emotion, for example, dissatisfaction or anger satisfies a criterion, a possibility that a deficiency or an anomaly has occurred in the region is high. In view of the above, in a case where a result of an emotion analysis using an image satisfies a criterion, the emotion estimation apparatus 10 outputs predetermined information to a terminal 20. The terminal 20 is, for example, a terminal that a manager in charge of the region views.

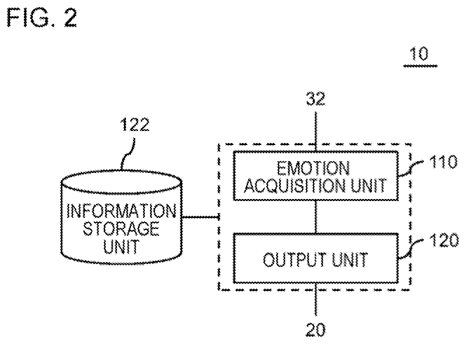

FIG. 2 is a diagram illustrating one example of a functional configuration of the emotion estimation apparatus 10. In the example illustrated in FIG. 2, the emotion estimation apparatus 10 includes an emotion acquisition unit 110 and an output unit 120.

The emotion acquisition unit 110 acquires, for each of a plurality of regions within a facility, an estimated value related to magnitude of specific emotion being felt by at least one person being present in the region. A specific example of the estimated value is described later with reference to a flowchart. In the present example embodiment, the emotion acquisition unit 110 acquires the estimated value by processing an image generated by the image capturing unit 32.

When there is a region where the estimated value satisfies a criterion, the output unit 120 outputs information that identifies the region. In the present example embodiment, the criterion is set for each of a plurality of regions. However, the criterion may be common between at least two regions.

In the present example embodiment, a criterion to be used by the output unit 120 is stored in an information storage unit 122. The information storage unit 122 stores region identification information, and a criterion to be used in a region associated with the region identification information, for example, a reference value, in association with each other. Further, the information storage unit 122 stores image capturing unit identification information of the image capturing unit 32 in association with region identification information of a region where the image capturing unit 32 is installed.

Further, the information storage unit 122 stores information that identifies the terminal 20 being an output destination, for example, address information such as an IP address, in association with at least either one of image capturing unit identification information and region identification information. The output unit 120 sets the terminal 20 being an output destination, for each image capturing unit 32, specifically, for each region, by using the information.

In the example illustrated in FIG. 2, the information storage unit 122 is a part of the emotion estimation apparatus 10. However, the information storage unit 122 may be located outside the emotion estimation apparatus 10.

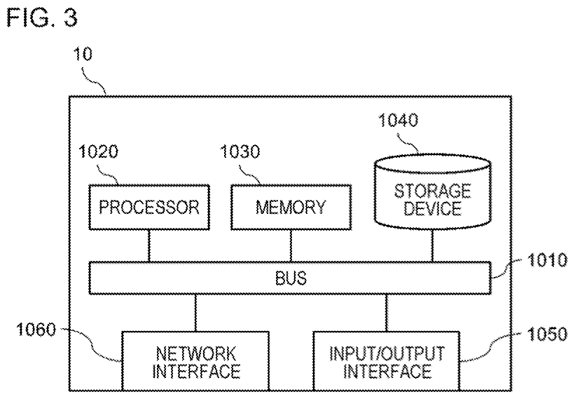

FIG. 3 is a diagram illustrating a hardware configuration example of the emotion estimation apparatus 10. The emotion estimation apparatus 10 includes a bus 1010, a processor 1020, a memory 1030, a storage device 1040, an input/output interface 1050, and a network interface 1060.

The bus 1010 is a data transmission path along which the processor 1020, the memory 1030, the storage device 1040, the input/output interface 1050, and the network interface 1060 mutually transmit and receive data. However, a method of mutually connecting the processor 1020 and the like is not limited to bus connection.

The processor 1020 is a processor to be achieved by a central processing unit (CPU), a graphics processing unit (GPU), or the like.

The memory 1030 is a main storage apparatus to be achieved by a random access memory (RAM) or the like.

The storage device 1040 is an auxiliary storage apparatus to be achieved by a hard disk drive (HDD), a solid state drive (SSD), a memory card, a read only memory (ROM), or the like. The storage device 1040 stores a program module that achieves each function (e.g., the emotion acquisition unit 110 and the output unit 120) of the emotion estimation apparatus 10. The processor 1020 achieves each function associated with each program module by reading each of these program modules in the memory 1030 and executing each of these program modules. Further, the storage device 1040 also functions as the information storage unit 122.

The input/output interface 1050 is an interface for connecting the emotion estimation apparatus 10 and various input/output devices.

The network interface 1060 is an interface for connecting the emotion estimation apparatus 10 to a network. The network is, for example, a local area network (LAN) or a wide area network (WAN). A method of connecting the network interface 1060 to a network may be wireless connection or may be wired connection. The emotion estimation apparatus 10 may communicate with the terminal 20 and the image capturing unit 32 via the network interface 1060.

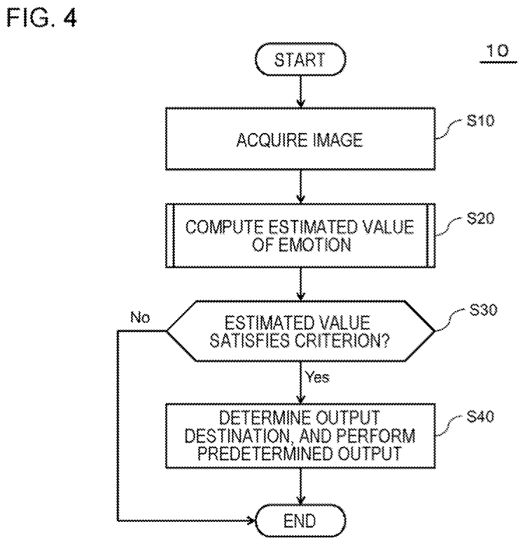

FIG. 4 is a flowchart illustrating an operation example of the emotion estimation apparatus 10. The emotion estimation apparatus 10 performs processing illustrated in FIG. 4 at a fixed time interval, and for each of the plurality of image capturing units 32.

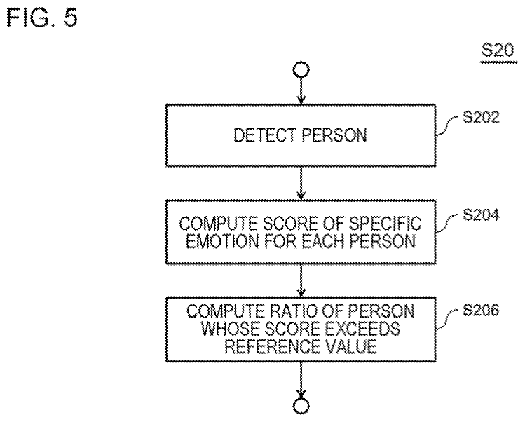

When an image is generated, the image capturing unit 32 transmits the generated image to the emotion estimation apparatus 10 together with image capturing unit identification information of the image capturing unit 32. When acquiring, from the image capturing unit 32, the image and the image capturing unit identification information (step S10), the emotion acquisition unit 110 of the emotion estimation apparatus 10 computes an estimated value related to specific emotion by processing the image (step S20). Details of the step S20 will be described later with reference to FIGS. 5 to 7.

Then, the output unit 120 determines whether the estimated value computed in the step S20 satisfies a criterion (step S30). The criterion to be used herein is, for example, stored in the information storage unit 122. The output unit 120 reads, from the information storage unit 122, a criterion associated with a region (specifically, the image capturing unit 32) to be processed, and uses the criterion. A specific example of the criterion will be described later with reference to FIGS. 5 to 7.

Then, when the estimated value satisfies the criterion (step S30: Yes), the output unit 120 reads, from the information storage unit 122, identification information of the terminal 20 being associated with the image capturing unit identification information acquired in the step S10. Then, the output unit 120 outputs, to the terminal 20 indicated by the read identification information, predetermined information (Step S40). Herein, predetermined information to be output is, for example, at least either one of information indicating that a deficiency or an anomaly has occurred in a region associated with the image capturing unit 32, and information that identifies a region associated with the image capturing unit 32.

FIG. 5 is a flowchart illustrating a first example of processing to be performed in the step S20 in FIG. 4. First, the emotion acquisition unit 110 detects a person included in an image. Herein, in a case where a plurality of persons are included in an image, the emotion acquisition unit 110 detects each of these plurality of persons (step S202).

Then, the emotion acquisition unit 110 computes a score of specific emotion, for each of the persons detected in the step S202 (step S204). Herein, the specific emotion is, for example, dissatisfaction or anger. A higher score indicates that emotion is strong. The emotion acquisition unit 110 computes a score of specific emotion, for example, from a facial expression or an attitude of a person. For example, in a case where specific emotion is a degree of dissatisfaction, a score of a person becomes high, in a case where a frowned face, an angry face, raising an arm, or the like is detected.

Then, the emotion acquisition unit 110 computes a ratio of a person whose computed score exceeds a first reference value with respect to the persons determined in the step S202 (step S206). The first reference value to be used herein is stored, for example, in the information storage unit 122. The first reference value may be set for each region (specifically, for each image capturing unit 32). In this case, the emotion acquisition unit 110 reads, from the information storage unit 122, the first reference value associated with a region (specifically, an image capturing unit 32) to be processed.

Note that, in a case where a facility is an airport, and the first reference value is set for each region, a region where the first reference value is to be set high is, for example, in front of a check-in counter, in front of a security checkpoint, and in front of an immigration office.

Then, the output unit 120 sets, as an estimated value to be used in the step S30 in FIG. 4, the ratio computed in the step S206. A criterion to be used in the step S30 is that an estimated value becomes equal to or more than a second reference value. The information storage unit 122 stores the second reference value for each region (specifically, for each image capturing unit 32).

Note that, in a case where a facility is an airport, and the second reference value is set for each region, a region where the second reference value is to be set high is, for example, in front of a check-in counter, in front of a security checkpoint, and in front of an immigration office.

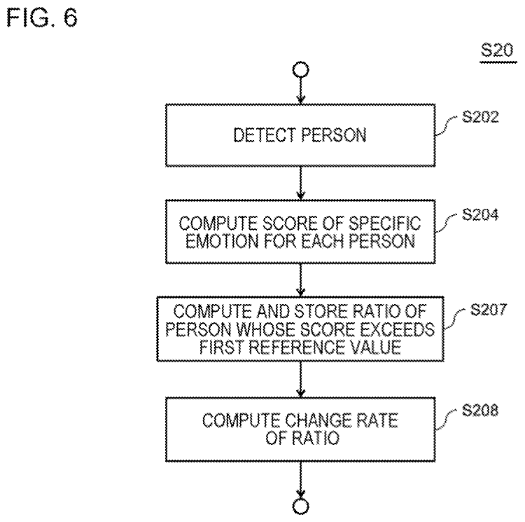

FIG. 6 is a flowchart illustrating a second example of processing to be performed in the step S20 in FIG. 4. In the flowchart illustrated in FIG. 6, a condition for output predetermined information by the output unit 120 is that the number of persons having specific emotion is increasing.

In the present example, processing to be performed in steps S202 and S204 is similar to processing to be performed in the steps S202 and S204 of the first example.

The emotion acquisition unit 110 computes a ratio of a person whose computed score exceeds the first reference value with respect to the persons determined in the step S202, and stores the computed ratio, for example, in the information storage unit 122 (step S207). A method of computing the ratio is similar to the step S206 in FIG. 5.

Then, the output unit 120 computes at least either one of a change rate and a change amount of a computed ratio by using the ratio and a ratio that has been computed previously (step S208). The output unit 120 sets, as an estimated value to be used in the step S30 in FIG. 4, at least either one of the change rate and the change amount computed in the step S208. A criterion to be used in the step S30 is that a change value becomes equal to or more than a third reference value. The information storage unit 122 stores the third reference value for each region (specifically, for each image capturing unit 32).

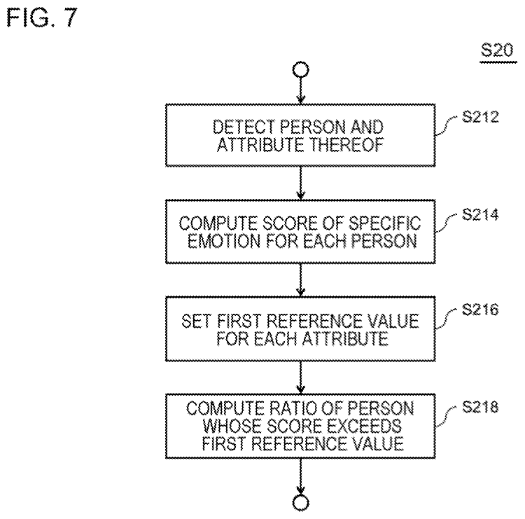

FIG. 7 is a flowchart illustrating a third example of processing to be performed in the step S20 in FIG. 4. In the present example embodiment, the emotion acquisition unit 110 determines an attribute of a person, and computes, by using the attribute, an estimated value to be used by the output unit 120.

First, the emotion acquisition unit 110 detects a person included in an image, and detects an attribute of the person. The attribute is, for example, at least one of an age group, a gender, and a race. Herein, in a case where an image includes a plurality of persons, the emotion acquisition unit 110 detects each of these plurality of persons, together with an attribute of the person (step S212).

Then, the emotion acquisition unit 110 computes a score of specific emotion, for each of the persons detected in the step S212 (step S214). Processing to be performed herein is similar to processing to be performed in the step S204 in FIG. 5.

The information storage unit 122 stores the first reference value for each region and for each attribute. Then, the emotion acquisition unit 110 sets the first reference value for each attribute by using information stored in the information storage unit 122 in association with a region (specifically, an image capturing unit 32) to be processed (step S216). Then, the emotion acquisition unit 110 computes a ratio of a person whose computed score exceeds the first reference value associated with an attribute of the person with respect to the persons determined in the step S212 (step S218).

Then, the output unit 120 sets, as an estimated value to be used in the step S30 in FIG. 4, the ratio computed in the step S218. Similarly to the example in FIG. 5, a criterion to be used in the step S30 is that an estimated value becomes equal to or more than the second reference value.

Note that, the steps S217 and S218 in FIG. 6 may be performed, instead of the step S218 in FIG. 7.

As described above, according to the present example embodiment, the emotion estimation apparatus 10 computes an estimated value of magnitude of specific emotion (e.g., dissatisfaction) of a person being present in a certain region of a facility by processing an image acquired by photographing the region. Then, when the estimated value satisfies a criterion, the emotion estimation apparatus 10 performs predetermined output. Therefore, by using the emotion estimation apparatus 10, it is possible to detect a deficiency or an anomaly that has occurred in a facility, based on emotion being felt by a person.

[Second Example Embodiment]

An emotion estimation apparatus 10 according to the present example embodiment is similar to the emotion estimation apparatus 10 according to the first example embodiment except for information to be included in an output of an output unit 120.

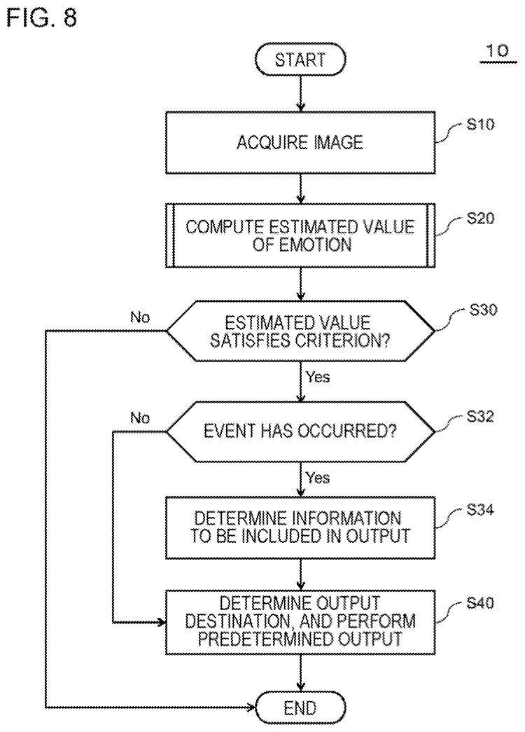

FIG. 8 is a flowchart illustrating processing to be performed by the emotion estimation apparatus 10 according to the present example embodiment. Processing to be performed in steps S10 to S30, and step S40 is similar to that in the first example embodiment. Then, when an estimated value satisfies a criterion (step S30: Yes), an emotion acquisition unit 110 of the emotion estimation apparatus 10 determines whether an event has occurred in a region to be processed by processing an image acquired in the step S10, and identifies repair of the event that has occurred (step S32).

Herein, examples of a kind of an event include, for example, that a lost child has occurred in the region, a danger has occurred in the region, a failure has occurred in equipment of the region, and the like. A determination criterion on a lost child is, for example, that a facial expression of a person who is estimated to be under a predetermined age satisfies a criterion (example: a crying face). Further, a determination criterion on occurrence of a danger is, for example, that a plurality of persons look at a same direction, and facial expressions of the plurality of persons indicate discomfort or fear.

When an event has occurred (step S32: Yes), the output unit 120 determines information being supposed to be included in an output according to a kind of the event. Information to be included includes, for example, a kind of a detected event, and an approach to an event. For example, an information storage unit 122 stores the information in association with a kind of an event. In this case, the output unit 120 reads, from the information storage unit 122, information being supposed to be included in an output. Then, the output unit 120 includes, in an output to be performed in the step S40, determined information, for example, information read from the information storage unit 122 (step S34).

Note that, in a case where an event has not occurred in the step S32 (step S32: No), an output to be performed in the step S40 is similar to that in the first example embodiment.

Also in the present example embodiment, an advantageous effect similar to that of the first example embodiment can be acquired. Further, the emotion estimation apparatus 10 determines, by image processing, an event that has occurred in a region where a criterion related to specific emotion is satisfied, and outputs, to a terminal 20, information according to a kind of the event. Therefore, a user of the terminal 20 can speedily cope with the event.

As described above, example embodiments according to the present invention have been described with reference to the drawings, however, these example embodiments are an example of the present invention, and various configurations other than the above can also be adopted.

Further, in a plurality of flowcharts used in the above description, a plurality of processes (pieces of processing) are described in order, however, an order of execution of processes to be performed in each example embodiment is not limited to the order of description. In each example embodiment, the order of illustrated processes can be changed within a range that does not adversely affect a content. Further, the above-described example embodiments can be combined, as far as contents do not conflict with each other.

A part or all of the above-described example embodiments may also be described as the following supplementary notes, but is not limited to the following.

1. An emotion estimation apparatus including:
an emotion acquisition unit that acquires for each of a plurality of regions within a facility, an estimated value related to magnitude of specific emotion being felt by at least one person being present in the region; and
an output unit that outputs predetermined information, when there is the region where the estimated value satisfies a criterion, wherein
the criterion is set for each of the plurality of regions.

2. The emotion estimation apparatus according to supplementary note 1, wherein
the output unit sets an output destination of the output, for the each region.

3. The emotion estimation apparatus according to supplementary note 1 or 2, wherein
the estimated value is a ratio of a person whose score indicating magnitude of specific emotion exceeds a first reference value, and
the criterion is that the estimated value exceeds a second reference value.

4. The emotion estimation apparatus according to supplementary note 1 or 2, wherein
the estimated value is at least either one of a change rate and a change amount of a ratio of a person whose score indicating magnitude of specific emotion exceeds a first reference value, and
the criterion is that the estimated value exceeds a third reference value.

5. The emotion estimation apparatus according to supplementary note 3 or 4, wherein
the emotion acquisition unit determines an attribute of the person, and computes the estimated value by using the attribute.

6. The emotion estimation apparatus according to any one of supplementary notes 1 to 5, wherein
the emotion acquisition unit
   computes the estimated value by processing an image acquired by photographing the region,
   identifies a kind of an event that has occurred in the region by further processing the image, and
the output unit includes, in the predetermined output, information according to the kind of the event.

7. The emotion estimation apparatus according to any one of supplementary notes 1 to 6, wherein
the facility is an airport, a station, a store, or an event venue.

8. The emotion estimation apparatus according to any one of supplementary notes 1 to 7, wherein
the specific emotion is dissatisfaction.

9. An emotion estimation method including:
by a computer,
acquiring, for each of a plurality of regions within a facility, an estimated value related to magnitude of specific emotion being felt by at least one person being present in the region; and
outputting predetermined information, when there is the region where the estimated value satisfies a criterion, wherein
the criterion is set for each of the plurality of regions.

10. The emotion estimation method according to supplementary note 9, further including,
by the computer,
setting an output destination of the output, for the each region.

11. The emotion estimation method according to supplementary note 9 or 10, wherein
the estimated value is a ratio of a person whose score indicating magnitude of specific emotion exceeds a first reference value, and
the criterion is that the estimated value exceeds a second reference value.

12. The emotion estimation method according to supplementary note 9 or 10, wherein
the estimated value is at least either one of a change rate and a change amount of a ratio of a person whose score indicating magnitude of specific emotion exceeds a first reference value, and
the criterion is that the estimated value exceeds a third reference value.

13. The emotion estimation method according to supplementary note 11 or 12, further including,
by the computer
determining an attribute of the person, and computing the estimated value by using the attribute.

14. The emotion estimation method according to any one of supplementary notes 9 to 13, further including:
by the computer,
computing the estimated value by processing an image acquired by photographing the region, and identifying a kind of an event that has occurred in the region by further processing the image; and
including, in the predetermined output, information according to the kind of the event.

15. The emotion estimation method according to any one of supplementary notes 9 to 14, wherein
the facility is an airport, a station, a store, or an event venue.

16. The emotion estimation method according to any one of supplementary notes 9 to 15, wherein
the specific emotion is dissatisfaction.

17. A program causing a computer to include:
a function of acquiring, for each of a plurality of regions within a facility, an estimated value related to magnitude of specific emotion being felt by at least one person being present in the region; and
a function of outputting predetermined information, when there is the region where the estimated value satisfies a criterion, wherein
the criterion is set for each of the plurality of regions.

18. The program according to supplementary note 17, further causing the computer to execute
setting an output destination of the output, for the each region.

19. The program according to supplementary note 17 or 18, wherein
the estimated value is a ratio of a person whose score indicating magnitude of specific emotion exceeds a first reference value, and
the criterion is that the estimated value exceeds a second reference value.

20. The program according to supplementary note 17 or 18, wherein
the estimated value is at least either one of a change rate and a change amount of a ratio of a person whose score indicating magnitude of specific emotion exceeds a first reference value, and
the criterion is that the estimated value exceeds a third reference value.

21. The program according to supplementary note 19 or 20, further causing the computer to execute
determining an attribute of the person, and computing the estimated value by using the attribute.

22. The program according to any one of supplementary notes 17 to 21, further causing the computer to execute:
computing the estimated value by processing an image acquired by photographing the region, and identifying a kind of an event that has occurred in the region by further processing the image; and
including, in the predetermined output, information according to the kind of the event.

23. The program according to any one of supplementary notes 17 to 22, wherein
the facility is an airport, a station, a store, or an event venue.

24. The program according to any one of supplementary notes 17 to 23, wherein
the specific emotion is dissatisfaction.

### Reference Signs List

10 Emotion estimation apparatus

20 Terminal

32 Image capturing unit

110 Emotion acquisition unit

120 Output unit

122 Information storage unit

What is claimed is:

1. An emotion estimation apparatus comprising:
at least one memory configured to store instructions; and
at least one processor configured to execute the instructions to perform operations comprising:
acquiring, for each of a plurality of regions within a facility, an estimated value related to magnitude of specific emotion being felt by at least one person being present in the region; and
outputting predetermined information, when there is the region where the estimated value satisfies a criterion, wherein
the criterion is set for each of the plurality of regions.

2. The emotion estimation apparatus according to claim 1, wherein the operations comprise
setting an output destination of the output, for the each region.

3. The emotion estimation apparatus according to claim 1, wherein
the estimated value is a ratio of a person whose score indicating magnitude of specific emotion exceeds a first reference value, and
the criterion is that the estimated value exceeds a second reference value.

4. The emotion estimation apparatus according to claim 1, wherein
the estimated value is at least either one of a change rate and a change amount of a ratio of a person whose score indicating magnitude of specific emotion exceeds a first reference value, and
the criterion is that the estimated value exceeds a third reference value.

5. The emotion estimation apparatus according to claim 3, wherein the operations comprise
determining an attribute of the person; and
computing the estimated value by using the attribute.

6. The emotion estimation apparatus according to claim 1, wherein the operations comprise
computing the estimated value by processing an image acquired by photographing the region,
identifying a kind of an event that has occurred in the region by further processing the image, and
including, in the predetermined information, information according to the kind of the event.

7. The emotion estimation apparatus according to claim 1, wherein
the facility is an airport, a station, a store, or an event venue.

8. The emotion estimation apparatus according to claim 1 wherein
the specific emotion is dissatisfaction.

9. An emotion estimation method comprising:
by a computer,
acquiring, for each of a plurality of regions within a facility, an estimated value related to magnitude of specific emotion being felt by at least one person being present in the region; and
outputting predetermined information, when there is the region where the estimated value satisfies a criterion, wherein
the criterion is set for each of the plurality of regions.

10. A non-transitory computer readable medium storing a program causing a computer to perform operations comprising:
acquiring, for each of a plurality of regions within a facility, an estimated value related to magnitude of specific emotion being felt by at least one person being present in the region; and
outputting predetermined information, when there is the region where the estimated value satisfies a criterion, wherein
the criterion is set for each of the plurality of regions.

11. The emotion estimation method according to claim 9, wherein the method further comprises
setting an output destination of the output, for the each region.

12. The emotion estimation method according to claim 9, wherein
the estimated value is a ratio of a person whose score indicating magnitude of specific emotion exceeds a first reference value, and
the criterion is that the estimated value exceeds a second reference value.

13. The emotion estimation method according to claim 9, wherein
the estimated value is at least either one of a change rate and a change amount of a ratio of a person whose score indicating magnitude of specific emotion exceeds a first reference value, and
the criterion is that the estimated value exceeds a third reference value.

14. The emotion estimation method according to claim 12, wherein the method further comprises
determining an attribute of the person; and
computing the estimated value by using the attribute.

15. The emotion estimation method according to claim 9, wherein the method further comprises
computing the estimated value by processing an image acquired by photographing the region,
identifying a kind of an event that has occurred in the region by further processing the image, and
including, in the predetermined information, information according to the kind of the event.

16. The non-transitory computer readable medium according to claim 10, wherein the operations comprise
setting an output destination of the output, for the each region.

17. The non-transitory computer readable medium according to claim 10, wherein
the estimated value is a ratio of a person whose score indicating magnitude of specific emotion exceeds a first reference value, and
the criterion is that the estimated value exceeds a second reference value.

18. The non-transitory computer readable medium according to claim 10, wherein
the estimated value is at least either one of a change rate and a change amount of a ratio of a person whose score indicating magnitude of specific emotion exceeds a first reference value, and
the criterion is that the estimated value exceeds a third reference value.

19. The non-transitory computer readable medium according to claim 17, wherein the operations further comprise
determining an attribute of the person; and
computing the estimated value by using the attribute.

20. The non-transitory computer readable medium according to claim 10, wherein the operations further comprise
computing the estimated value by processing an image acquired by photographing the region,
identifying a kind of an event that has occurred in the region by further processing the image, and
including, in the predetermined information, information according to the kind of the event.
